(19) United States
(12) Patent Application Publication
(10) Pub. No.: US 2021/0149539 A1
(43) Pub. Date: May 20, 2021

(54) TOUCH-PANEL-INTEGRATED DISPLAY DEVICE

(71) Applicant: SHARP KABUSHIKI KAISHA, Sakai City, Osaka (JP)

(72) Inventors: KOSUKE NAGATA, Sakai City (JP); MIKIHIRO NOMA, Sakai City (JP); MASAYUKI HACHINODA, Sakai City (JP); MASAYUKI HATA, Sakai City (JP); YOSHITAKA ORITA, Sakai City (JP); DAIJI KITAGAWA, Sakai City (JP); TOMOHIKO NISHIMURA, Sakai City (JP)

(73) Assignee: SHARP KABUSHIKI KAISHA, Sakai City, Osaka (JP)

(21) Appl. No.: 16/319,130

(22) PCT Filed: Jul. 18, 2017
(86) PCT No.: PCT/JP2017/025906

§ 371 Date: Jan. 18, 2019

(30) Foreign Application Priority Data
Jul. 19, 2016 (JP) 2016-141091

(51) Int. Cl. G06F 3/041; G06F 3/044; G09G 3/36

(52) U.S. Cl. CPC G06F 3/04166; G06F 3/044; G06F 3/0412; G09G 3/3685; G09G 3/3648; G09G 3/3674

(57) ABSTRACT

Provided is a touch-panel-integrated display device that, even in a case where it is caused to operate in the wake-up mode, flicker does not occur when the device returns from the sleep state. The touch-panel-integrated display device includes a plurality of electrodes provided in the display area, and a plurality of lines that are connected with the electrodes, wherein a touch scan signal is supplied to the plurality of lines, and a touch operation is detected based on changes in capacitances of the electrodes. When a predetermined time has elapsed since the last time a touch operation was detected, an operation state is shifted to a sleep state in which updating of display in the display panel is stopped. When a touch operation is detected by a detection circuit in the sleep state, the updating of the display in the display panel is resumed. In the sleep state, a potential of one of the source lines that overlaps with one of the plurality of lines to which the touch scan signal is supplied is controlled so that no potential difference occurs between both ends of an electrostatic capacitor of the pixel between the said line and the said source line.

### TECHNICAL FIELD

The present invention relates to a touch-panel-integrated display device.

### BACKGROUND ART

In recent years, touch-panel-equipped display devices have been widely used. Nowadays, so-called in-cell type touch-panel-integrated display device, having a sensor mechanism for detecting a touch position within pixels of a display panel, have been known.

Patent Document 1 discloses an example of such a touch-panel-integrated display device. In the configuration of Patent Document 1, in a display area that includes pixels defined by gate lines and data lines, a plurality of electrodes that function as touch sensors or common electrodes are arranged so as to overlap with the pixels. Further, in the display area, connection lines for applying a common voltage or touch scan voltages to the electrodes. In the configuration of Patent Document 1, the panel is driven by switching the mode between the display driving mode and the touch driving mode in a time-division manner, and a touch position is detected in the self-capacitance method. In the display driving mode, a common voltage is applied to the electrodes through the connection lines so that an image is displayed, and in the touch driving mode, touch scan signals are applied to the electrodes through the connection lines so that a touch position is detected.

### PRIOR ART DOCUMENT

### Patent Document

Patent Document 1: JP-A-2014-164752

### SUMMARY OF THE INVENTION

### Problem to be Solved by the Invention

In the conventional touch-panel-integrated display device, in some cases, when a touch operation or the like has not been done over a predetermined time, the display device is made in a non-display state (sleep state) in which the backlight of the display is turned off and the display operation is stopped, in order to reduce electric power consumption. Even in the non-display state, however, the touch sensors keep operating, and when a touch operation is made, the touch sensors detect this, the backlight is turned on, and the display operation is resumed. Such an operation mode is called “wake-up mode” in some cases.

In the case of the above-mentioned wake-up mode, even in the sleep state as well, a touch scan signal is applied to the electrodes functioning as the touch sensors via the above-described connection lines. In a case where the connection lines are arrayed in parallel with data lines of the display, however, charges are generated in display pixel portions due to the touch scan signal applied during the sleep state. These charges cause the following problem; flicker is visualized on the display, when the device returns from the sleep state, during a period from the turning-on of the backlight to the disappearance of the charges.

It is an object of the present invention to provide such a touch-panel-integrated display device that, even in a case where it is caused to operate in the wake-up mode, flicker does not occur when the device returns from the sleep state.

### Means to Solve the Problem

To achieve the above-described object, an exemplary touch-panel-integrated display device disclosed below includes a display panel that includes a plurality of gate lines and a plurality of data lines that intersect with the gate lines, and has a display area in which pixels defined by the gate lines and the source lines are arranged; a gate line driving circuit that supplies a gate driving signal to the gate lines; a source line driving circuit that supplies a data signal to the source lines; a plurality of electrodes provided in the display area; a plurality of lines that are connected with the electrodes; and a detection circuit that supplies a touch scan signal to the plurality of lines, and detects a touch operation based on changes in capacitances in the electrodes. The source lines and the plurality of lines are provided in parallel. The touch-panel-integrated display device further includes: a control circuit that, when a predetermined time has elapsed since the last time a touch operation was detected by the detection circuit, causes an operation state of the touch-panel-integrated display device to be a sleep state in which updating of display in the display panel is stopped, and when a touch operation is detected by the detection circuit in the sleep state, resumes the updating of the display in the display panel, wherein, in the sleep state, the control circuit controls a potential of one of the source lines that overlaps with one of the plurality of lines to which the touch scan signal is supplied so that no potential difference occurs between both ends of an electrostatic capacitor of the pixel between the said line and the said source line.

### Effect of the Invention

With the above-described configuration, such a touch-panel-integrated display device can be provided that, even in a case where it is caused to operate in the wake-up mode, flicker does not occur when the device returns from the sleep state.

### BRIEF DESCRIPTION OF DRAWINGS

FIG. 1 is a schematic cross-sectional view illustrating a schematic configuration of a touch-panel-integrated display device in Embodiment 1.

FIG. 2 is a schematic plan view illustrating a schematic configuration of an active matrix substrate illustrated in FIG. 1.

FIG. 3 is a schematic plan view illustrating an exemplary arrangement of counter electrodes formed in the active matrix substrate.

FIG. 4 is an enlarged schematic plan view illustrating a part of the area of the active matrix substrate.

FIG. 5 is a circuit diagram illustrating an equivalent circuit of a pixel in a normal driving state.

FIG. 6 is a circuit diagram illustrating an equivalent circuit of a pixel in a sleep state.

FIG. 7 is a circuit diagram illustrating an equivalent circuit of a pixel in a sleep state.

FIG. 8 is a flowchart illustrating operations of the touch-panel-integrated display device according to Embodiment 1.

FIG. 9 is a flowchart illustrating operations of the touch-panel-integrated display device according to Embodiment 2.

FIG. 10 is a circuit diagram illustrating an equivalent circuit of a pixel in a sleep state in Embodiment 2.

### MODE FOR CARRYING OUT THE INVENTION

A touch-panel-integrated display device according to the first configuration includes: a display panel that includes a plurality of gate lines and a plurality of data lines that intersect with the gate lines, and has a display area in which pixels defined by the gate lines and the source lines are arranged; a gate line driving circuit that supplies a gate driving signal to the gate lines; a source line driving circuit that supplies a data signal to the source lines; a plurality of electrodes provided in the display area; a plurality of lines that are connected with the electrodes; and a detection circuit that supplies a touch scan signal to the plurality of lines, and detects a touch operation based on changes in capacitances in the electrodes. The source lines and the plurality of lines are provided in parallel. The touch-panel-integrated display device further includes: a control circuit that, when a predetermined time has elapsed since the last time a touch operation was detected by the detection circuit, causes an operation state of the touch-panel-integrated display device to be a sleep state in which updating of display in the display panel is stopped, and when a touch operation is detected by the detection circuit in the sleep state, resumes the updating of the display in the display panel, wherein, in the sleep state, the control circuit controls a potential of one of the source lines that overlaps with one of the plurality of lines to which the touch scan signal is supplied so that no potential difference occurs between both ends of an electrostatic capacitor of the pixel between the said line and the said source line.

In other words, the first configuration is a configuration of a touch-panel-integrated display device in which lines connected with a plurality of electrodes for detecting a touch operation are provided in parallel with the source lines. In this touch-panel-integrated display device, when a predetermined time has elapsed since the last time a touch operation was detected, an operation state of the touch-panel-integrated display device is caused to be a sleep state in which updating of display in the display panel is stopped. Further, when a touch operation is detected by the detection circuit in the sleep state, the updating of the display in the display panel is resumed. In the sleep state, the control circuit controls a potential of one of the source lines that overlaps with one of the plurality of lines to which the touch scan signal is supplied so that no potential difference occurs between both ends of an electrostatic capacitor of the pixel between the said line and the said source line.

This configuration makes it possible to prevent a pixel potion connected to the line to which the touch scan signal is supplied and the source line that is parallel with the foregoing line and overlaps with the foregoing line from being charged due to a capacitor between the foregoing line and the foregoing source line in the sleep state. As a result, when the device returns from the sleep state and the updating of the display is resumed, flicker caused by the charging described above can be suppressed.

The first configuration may be such that, during the sleep state, the control circuit supplies, to one of the source lines that overlaps with one of the plurality of lines to which the touch scan signal is supplied, the same signal as the touch scan signal supplied to the one of the plurality of lines (the second configuration).

According to the second configuration, during the sleep state, the same signal as the touch scan signal is supplied to the source line that is parallel with the line to which the touch scan signal is supplied and overlaps with the foregoing line, whereby the pixel portion connected to these lines is prevented from being charged. Incidentally, the same signal as the touch scan signal means a signal that has the same amplitude (potential) as that of the touch scan signal and whose potential changes at the same timings. As a result, when the device returns from the sleep state and the updating of the display is resumed, flicker caused by the charging described above can be suppressed.

The first configuration may be such that, during the sleep state, the control circuit causes one of the source lines that overlaps with one of the plurality of lines to which the touch scan signal is supplied to be in a floating state (the third configuration).

According to the third configuration, during the sleep state, the source line that overlaps with the line to which the touch scan signal is supplied is caused to be in a floating state, whereby the pixel portion connected to these lines is prevented from being charged. As a result, when the device returns from the sleep state and the updating of the display is resumed, flicker caused by the charging described above can be suppressed.

### Embodiment 1

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

### (1. Configuration of Touch-Panel-Integrated Display Device)

First, the following description describes a configuration of a touch-panel integrated display device in the present embodiment. FIG. 1 is a cross-sectional view of a touch-panel-integrated display device 10 in the present embodiment. The touch-panel-integrated display device 10 in the present embodiment includes an active matrix substrate 1, a counter substrate 2, and a liquid crystal layer 3 interposed between the active matrix substrate 1 and the counter substrate 2. Each of the active matrix substrate 1 and the counter substrate 2 includes a glass substrate that is substantially transparent (having high translucency). The counter substrate 2 includes color filters (not shown). Further, though the illustration is omitted, the touch-panel-integrated display device 10 includes a backlight that is provided so as to extend in a surface direction of the active matrix substrate 1 on a side opposite to the liquid crystal layer 3 in FIG. 1.

The touch-panel-integrated display device 10 has a function of displaying an image, and at the same time, has a function of detecting a position that a user touches on the displayed image (touch position). This touch-panel-integrated display device 10 is a so-called in-cell type touch panel display device in which elements necessary for detecting a touch position are formed in the active matrix substrate 1.

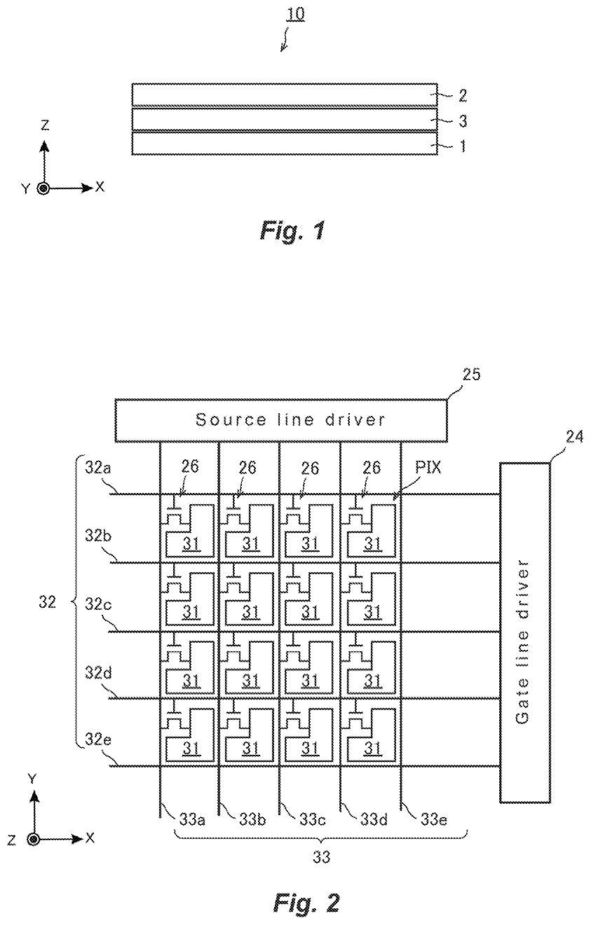

FIG. 2 is a plan view illustrating a schematic configuration of the active matrix substrate 1 illustrated in FIG. 1. As illustrated in FIG. 2, a plurality of gate lines 32, and a plurality of source lines 33 that intersect with the gate lines 32, are provided on the active matrix substrate 1. In pixels PIX defined by the gate lines 32 and the source lines 33, switching elements 26 connected with the gate lines 32 and the source lines 33, and pixel electrodes 31 connected with the switching elements 26, are provided. The switching elements 26 are, for example, thin film transistors (TFTs).

The gate lines 32 are connected with a gate line driver 24 provided outside the display area of the active matrix substrate 11. The gate line driver 24 applies a voltage for switching the state of each gate line 32 into a selected state, to the gate lines 32a, 32b, 32c, . . . sequentially one by one every horizontal scanning period.

The source lines 33 are connected to a source line driver 26 provided outside the display area of the active matrix substrate 11. The source line driver 25 supplies data signals corresponding to gray levels of an image to be displayed, to the source lines 26, respectively, during the image display period.

In the case of the touch-panel-integrated display device 10, the method for driving liquid crystal molecules contained in the liquid crystal layer 3 is the horizontal electric field driving method. To realize the horizontal electric field driving method, pixel electrodes and counter electrodes (also referred to as common electrodes) for forming electric fields are formed in the active matrix substrate 1.

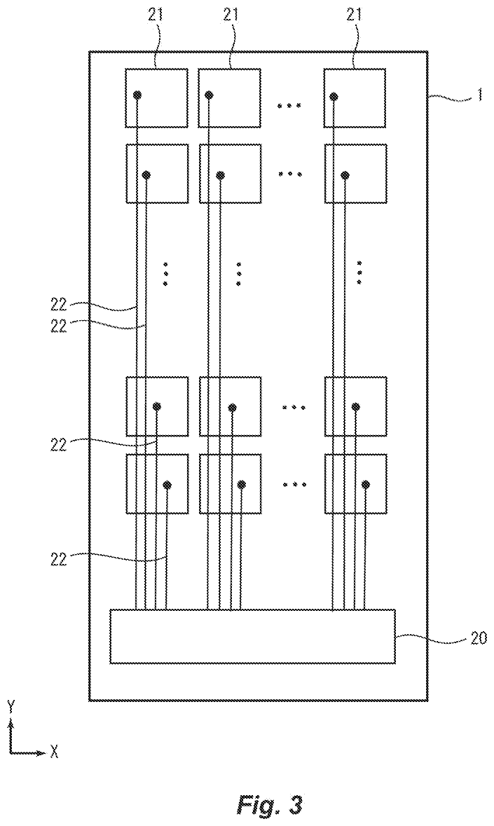

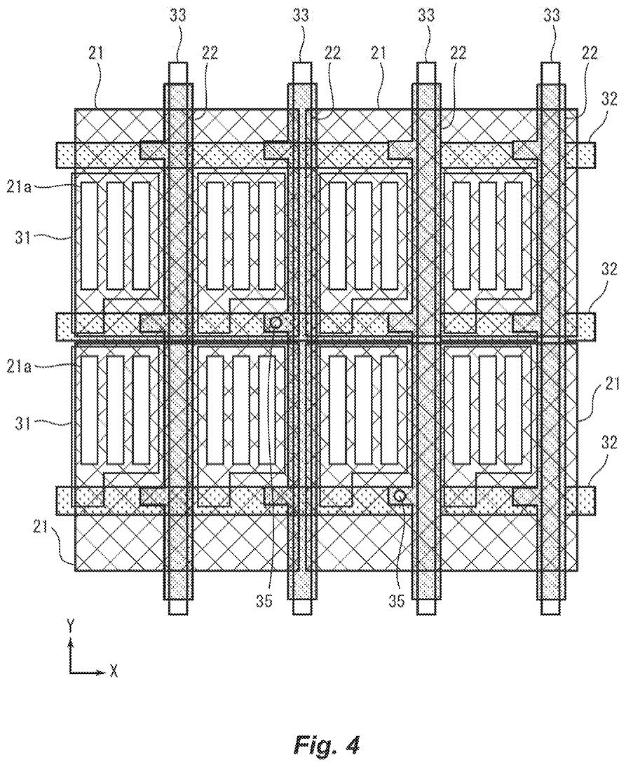

FIG. 3 schematically illustrates an exemplary arrangement of the counter electrodes 21 formed in the active matrix substrate 1. The counter electrodes 21 are formed on a liquid crystal layer 3 side surface of the active matrix substrate 1. As illustrated in FIG. 3, the counter electrode 21 is in a rectangular shape, and a plurality of the counter electrodes 21 are arrayed in matrix on the active matrix substrate 1. Each counter electrode 21 is, for example, in an approximately square shape whose side is approximately several millimeters (for example, about 4 mm). Though the illustration is omitted in FIG. 3, slits (having a width of, for example, several micrometers) for causing horizontal electric fields to be generated between the counter electrodes 21 and the pixel electrodes are formed in the counter electrodes 21 (see FIG. 4 mentioned below).

On the active matrix substrate 1, a controller 20 is provided. The controller 20 performs a controlling operation for displaying an image, and at the same time, performs a controlling operation for detecting a touch position.

The controller 20 and each counter electrode 21 are connected by signal lines 22 extending in the Y axis direction. More specifically, the same number of the signal lines 22 as the number of the counter electrodes 21 are formed on the active matrix substrate 1.

The touch-panel-integrated display device 10 performs an operation in which it works as a touch panel, and an operation in which it works as a display, in a time-division manner. The counter electrodes 21 are driven as sensors independent from one another, during an operation in which it works as a touch panel; the counter electrodes 21 are paired with the pixel electrodes to be described below to perform the image display control during an operation in which it works as a display.

Regarding the counter electrodes 21, parasitic capacitances are formed between the same and adjacent ones of the counter electrodes 21 or the like. When a human finger or the like touches the display screen of the touch-panel-integrated display device 10, capacitors are formed between the same and the human finger or the like, and electrostatic capacitances increase. During the control for touch position detection, the controller 20 supplies a touch scan signal to the counter electrodes 21 through the signal lines 22, and receives a touch detection signal through the signal lines 22. By doing so, the controller 20 detects changes in the electrostatic capacitances at the positions of the counter electrodes 21, and detects a touch position. This touch position detection method is a so-called self-capacitance method. In other words, the signal lines 22 function as lines for the transmission/reception of the touch scan signal and the touch detection signal.

FIG. 4 is an enlarged schematic diagram illustrating a part of the area of the active matrix substrate 1. As illustrated in FIG. 4, a plurality of the pixel electrodes 31 are arranged in matrix. Incidentally, as described above, a plurality of the slits 21a for generating horizontal electric fields between the counter electrodes 21 and the pixel electrodes 31 are provided in the counter electrodes 21. FIG. 4 illustrates an exemplary configuration in which three slits 21a are formed with respect to each pixel electrode 31, but the number of the slits is not limited to this.

Each of the pixel electrodes 31 is connected to the gate line 32 and the source line 33. Each gate line 32 extends in the X axis direction, and a plurality of the same are arrayed at predetermined intervals in the Y axis direction. Each source line 33 extends in the Y axis direction, and a plurality of the same are arrayed at predetermined intervals in the X axis direction. In other words, the gate lines 32 and the source lines 33 are formed in a lattice form, and the pixel electrodes 31 are provided in the areas defined by the gate lines 32 and the source lines 33, respectively. The gate electrode of each TFT 26 (see FIG. 2) is connected with the gate line 32, either the source electrode or the drain electrode of the TFT 26 is connected with the source line 33, and the other one is connected with the pixel electrode 31.

On the counter substrate 2 (see FIG. 1), color filter of three colors of red (R), green (G), and blue (B) are provided so as to correspond to the pixel electrodes 31, respectively. With this configuration, each of the pixel electrodes 31 functions as a subpixel of any one of the colors of R, G, and B.

As illustrated in FIG. 4, the signal lines 22 extending in the Y axis direction are arranged so as to partially overlap, in the normal line direction of the active matrix substrate 1, with the source lines 33 extending in the Y axis direction. More specifically, the signal lines 22 are provided in a layer lower with respect to the source lines 33. Besides, the signal lines 22 and the source lines 33 partially overlap with each other when viewed in a plan view, while the signal lines 22 are provided at positions that do not overlap with the TFTs. The counter electrodes 21 and the signal lines 22 are connected at connection portions 35.

### (2. Operation of Touch-Panel-Integrated Display Device)

Next, the following description describes operations of the touch-panel-integrated display device 10. The touch-panel-integrated display device 10 can operate in such a wake-up mode that the operation state is switched between the normal driving state and the sleep state according to the presence/absence of a touch operation. In the normal driving state, the touch-panel-integrated display device 10 performs an operation in which it works as a display, and an operation in which it works as a touch panel, together. In the sleep state, the touch-panel-integrated display device 10 performs only the operation in which it works as a touch panel, while keeping the display in a non-display state. In the present embodiment, the backlight is turned off during the sleep state. The sleep state, however, may be such that the backlight is not completely turned off, and the brightness of the backlight is decreased as compared with the normal driving state. Alternatively, the configuration may be such that the brightness of the backlight is decreased stepwise according to the time elapsed since the shift to the sleep state.

In the normal driving state, when a predetermined time has elapsed since the last input operation such as a touch operation or the like was done, the operation state is switched to the sleep state by the controller 20. On the other hand, in the sleep state, when an input operation such as a touch operation or the like is detected, the operation mode is switched to the normal driving state by the controller 20.

In the normal driving state, as described above, the touch-panel-integrated display device 10 performs an operation in which it works as a touch panel, and an operation in which it works as a display, in a time-division manner. For example, in one frame period, the controller 20 controls the gate line driver 24 and the source line driver 25 to display an image, and thereafter, in a blanking period, the controller 20 supplies the touch scan signal to the signal lines 22 simultaneously (or alternatively, sequentially) to detects a touch operation. Incidentally, the timing of detecting a touch operation may be an arbitrary timing as long as it does not overlap with the timing of image display. In a case where the display has a high frame rate, or in a case where the display has a high resolution (the numbers of the gate lines and the source lines are large), the blanking period is short; in such a case, the signal lines 22 may be divided into several groups, and the signal lines 22 may be driven group by group.

In the touch-panel-integrated display device 10 of the present embodiment, during the sleep state, the controller 20 supplies the touch scan signal to the signal lines 22. Further, the controller 20 sends, to the gate line driver 24, a control signal that instructs that the supply of the gate line driving signal to the gate lines 32 should be stopped. Still further, the controller 20 sends, to the source line driver 25, a control signal that instructs that the same signal as the touch scan signal supplied to the signal lines 22 should be supplied to the source lines 33.

This causes the same signals to be supplied to the signal lines 22 and the source lines 33 during the sleep state. In this way, by equalizing the voltages of the signal lines 22 and the source lines 33, differences in the potentials at the both ends of the pixel capacitances are eliminated, whereby abnormal charging of the pixels, and flicker of the display caused by the abnormal charging, can be suppressed. The following description describes the reason for this.

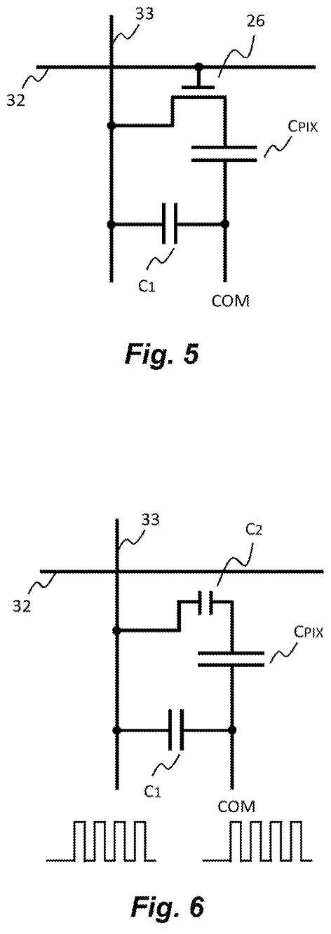

FIG. 5 is a circuit diagram illustrating an equivalent circuit of a pixel (a pixel corresponding to a selected gate line) in the normal driving state. FIG. 6 is a circuit diagram illustrating an equivalent circuit of a pixel in the sleep state.

As illustrated in FIG. 5, in the normal driving state, at a pixel corresponding to a selected gate line, a gate driving signal is supplied to the gate line 32, whereby the TFT 26 shifts to a conductive state. Further, a data signal is supplied to the source line 33, and a constant voltage (COM voltage) is supplied to the signal line 22, whereby a pixel capacitor C_{PIX} is charged to a gray level potential according to the data signal from the source line 33. Incidentally, there is a parasitic capacitor C₁ between the source line 33 and the signal line 22, the parasitic capacitor being caused by panel internal lines and the like.

On the other hand, in the sleep state, as illustrated in FIG. 6, the supply of the gate driving signal to the gate lines 32 is stopped, and the TFT 26 shifts to a non-conductive state. Further, the touch scan signal is supplied to the signal line 22, and the same signal as this touch scan signal (signal having the same timing and voltage) is supplied to the source line 33. C₂ illustrated in FIG. 6 indicates a source-drain capacitor of the TFT 26.

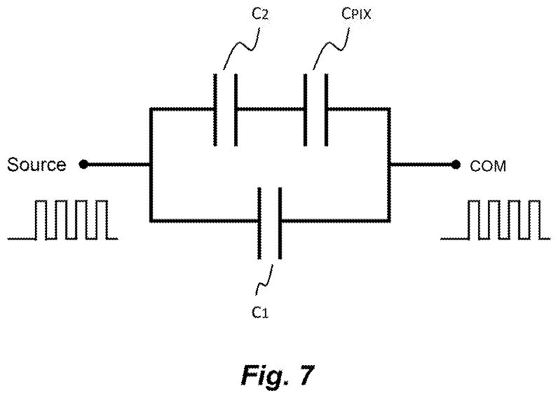

In this way, when the same signal is supplied to the signal line 22 and the source line 33 in the sleep state, no potential difference occurs between both ends of the pixel capacitor C_{PIX}, as illustrated in FIG. 7, and no abnormal charging occurs to the pixel. As a result, when the normal driving state is restored from the sleep state, flicker of the display after the backlight is turned on can be suppressed. In other words, in the configuration of the present embodiment in which the signal lines 22 and the source lines 33 are provided so as to overlap as illustrated in FIG. 4, if the sleep state is such that no signal is supplied to the source line 33 while the touch scan signal is supplied to the signal line 22, the following problem occurs: the pixel capacitor C_{PIX} is charged by a potential difference occurring between both ends of the pixel capacitor C_{PIX}, thereby causing flicker. This problem can be solved by supplying the same signals to the signal line 22 and the source line 33 during the sleep state.

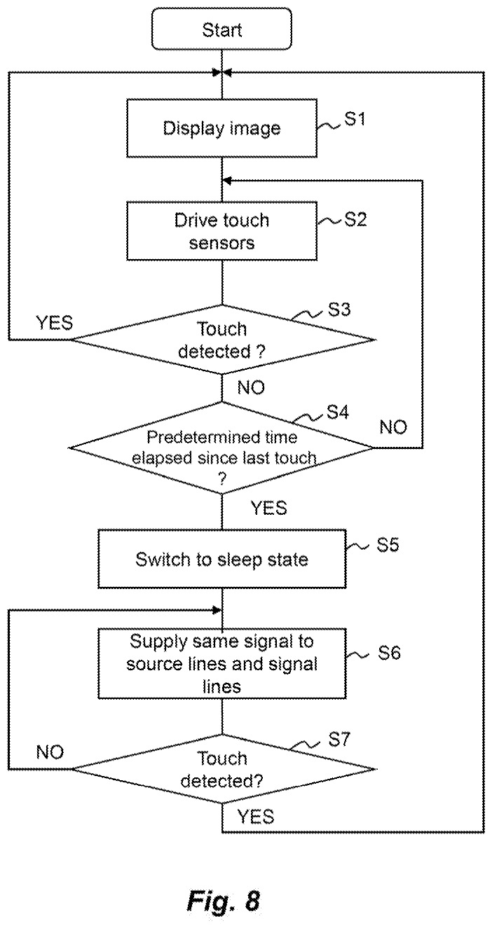

Here, operations of the touch-panel-integrated display device 10 according to the present embodiment (controlling operations by the controller 20) are described, with reference to the flowchart illustrated in FIG. 8.

When starting to operate in response to power supply or the like, the touch-panel-integrated display device 10, in the normal driving state, performs the image display (S1) and the driving of the counter electrodes 21 as the touch sensors (S2) in a time-division manner. In the step S1 described above, in order to display an image, the gate line driver 24 under the control by the controller 20, selects the plurality of gate lines 32 sequentially, and the source line driver 25 supplies, to the source lines 33, data signals according to the image to be displayed, as described above. Further, the controller 20 supplies a constant COM voltage from the signal lines 22 to the counter electrodes 21. Still further, in the step S2 described above, the controller 20 stops the gate line driver 24 and the source line driver 25, and supplies the touch scan signal from the signal lines 22 to the counter electrodes 21. Still further, the controller 20 reads touch detection signals form the counter electrodes 21 via the signal lines 22, and detects, based on the read touch detection signals, which of the counter electrodes 21 are touched (S3).

When a touch is detected in the step S3, the controller 20 sends a host device a signal indicating that the touch is detected, and performs an operation of displaying a new image according to an instruction from the host device (the flow goes back to S1). On the other hand, in a case where no touch is detected in the step S3, the controller 20 determines whether or not a predetermined time, which is preliminarily set, has elapsed since the last time a touch was detected (S4).

If the determination result in the step S4 is “YES” (the predetermined time has elapsed), the controller 20 switches the operation state from the normal driving state to the sleep state (S5). In the sleep state, as described above, the controller 20 stops the gate line driver 24, and supplies the touch scan signal from the signal lines 22 to the counter electrodes 21. Further, the controller 20 causes the same signal as the touch scan signal supplied to the signal lines 22 to be supplied from the source line driver 25 to the source lines 33 (S6). Then, when a touch is detected (YES at S7), the flow goes back to the step S1.

With the configuration and the operations described above, in the touch-panel-integrated display device 10 according to the present embodiment, the state can be switched from the normal driving state to the sleep state in a case where there is no touch operation during a predetermined period, and the normal driving state can be restored when a touch operation is made in the sleep state, and further, flicker in the display can be suppressed when the normal driving state is restored.

Incidentally, the touch scan signal supplied in the normal driving state during the blanking period to the counter electrodes 21, and the touch scan signal supplied in the sleep state to the counter electrodes 21 may have the same frequency, or alternatively, the latter may have a lower frequency than that of the former.

During the sleep state, in a case where all of the signal lines 22 are not simultaneously driven but are sequentially driven, or alternatively, divided into a plurality of blocks and driven block by block, the same signal as the touch scan signal is supplied only to the source lines 33 that overlap with the driven signal lines 22 when viewed in a plan view, and no signal is supplied to the other source lines 33. This makes it possible to suppress charges between the signal lines 22 to which the touch scan signal is supplied, and the source lines 33 overlapping with these signal lines 22 when viewed in a plan view, thereby suppressing flicker that would occur when the normal diving state is restored from the sleep state.

### Embodiment 2

A touch-panel-integrated display device 10 according to Embodiment 2 has the same configuration as that of Embodiment 1, but the driving of the source lines 33 during the sleep state is different from that in Embodiment 1.

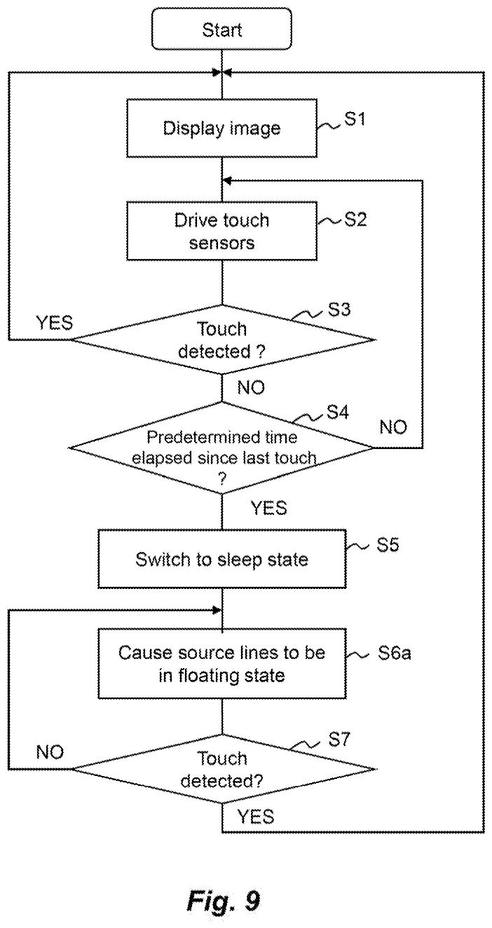

FIG. 9 is a flowchart illustrating operations of the touch-panel-integrated display device 10 according to Embodiment 2. As illustrated in FIG. 9, in the present embodiment, when the state is switched to the sleep state, the controller 20 sends, to the source line driver 25, an instruction for causing the source lines 33 to become in a floating state (S6a). To cause the source lines 33 to become in a floating state, the configuration may be, for example, such that switching elements are provided in connection parts where the source line driver 25 and the source lines 33 are connected, and when the state is switched to the sleep state, these switching elements become non-conductive in response to an instruction from the controller 20.

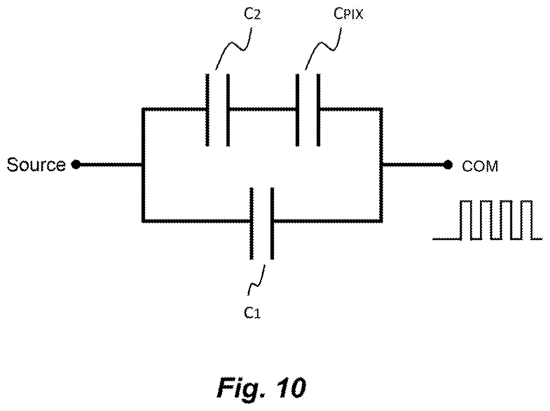

According to Embodiment 2 described above, the source lines 33 are caused to be in a floating state in the sleep state, whereby no potential difference occurs between the both ends of the pixel capacitor C_{PIX} as illustrated in FIG. 10, and no abnormal charging of the pixels occurs. As a result, when the normal driving state is restored from the sleep state, flicker in the display after the backlight is turned on can be suppressed. In other words, in the configuration of the present embodiment in which the signal lines 22 and the source lines 33 are provided to as to overlap with each other as illustrated in FIG. 4, if no signal is supplied to the source lines 33 while the touch scan signal is supplied to the signal lines 22 in the sleep state, the following problem arises: the pixel capacitor C_{PIX} is charged due to a potential difference occurring between both ends of the pixel capacitor C_{PIX}, thereby causing flicker. This problem can be solved by causing the source lines 33 to be in a floating state during the sleep state.

Examples of the touch-panel-integrated display device according to the present invention are described above, but the configuration of the touch-panel-integrated display device according to the present invention is not limited to the configurations of the above-described embodiments; a variety of modification configurations are applicable.

For example, the foregoing description describes an exemplary configuration in which the controller 20 has all of the functions of detecting a touch, controlling the supply of the touch scan signal to the signal lines 22, and controlling the gate line driver 24 and the source line driver 25, but these functions may be dispersed among a plurality of controllers so as to be controlled by these controllers.

### DESCRIPTION OF REFERENCE NUMERALS

1: active matrix substrate
2: counter substrate
3: liquid crystal layer
10: touch-panel-integrated display device
20: controller
21: counter electrode
22: signal line
31: pixel electrode
32: gate line
33: source line

1. A touch-panel-integrated display device comprising:
a display panel that includes a plurality of gate lines and a plurality of data lines that intersect with the gate lines, and has a display area in which pixels defined by the gate lines and the source lines are arranged;
a gate line driving circuit that supplies a gate driving signal to the gate lines;
a source line driving circuit that supplies a data signal to the source lines;
a plurality of electrodes provided in the display area;
a plurality of lines that are connected with the electrodes; and
a detection circuit that supplies a touch scan signal to the plurality of lines, and detects a touch operation based on changes in capacitances in the electrodes,
wherein the source lines and the plurality of lines are provided in parallel,
the touch-panel-integrated display device further comprising:
a control circuit that, when a predetermined time has elapsed since the last time a touch operation was detected by the detection circuit, causes an operation state of the touch-panel-integrated display device to be a sleep state in which updating of display in the display panel is stopped, and when a touch operation is detected by the detection circuit in the sleep state, resumes the updating of the display in the display panel,
wherein, in the sleep state, the control circuit controls a potential of one of the source lines that overlaps with one of the plurality of lines to which the touch scan signal is supplied so that no potential difference occurs between both ends of an electrostatic capacitor of the pixel between the said line and the said source line.

2. The touch-panel-integrated display device according to claim 1,
wherein, during the sleep state, the control circuit supplies, to one of the source lines that overlaps with one of the plurality of lines to which the touch scan signal is supplied, the same signal as the touch scan signal supplied to the one of the plurality of lines.

3. The touch-panel-integrated display device according to claim 1,
wherein, during the sleep state, the control circuit causes one of the source lines that overlaps with one of the plurality of lines to which the touch scan signal is supplied to be in a floating state.
